(19) United States
(12) Patent Application Publication
(10) Pub. No.: US 2008/0204737 A1
(43) Pub. Date: Aug. 28, 2008

(54) MASK PATTERN INSPECTION APPARATUS WITH KOEHLER ILLUMINATION SYSTEM USING LIGHT SOURCE OF HIGH SPATIAL COHERENCY

(75) Inventors: Riki OGAWA, Kanagawa (JP); Masatoshi HIRONO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Advanced Mask Inspection Technology Inc., Yokohama-shi (JP)

(21) Appl. No.: 12/035,685

(22) Filed: Feb. 22, 2008

(30) Foreign Application Priority Data
Feb. 27, 2007 (JP) 2007-046341

(51) Int. Cl. G01N 21/00

(52) U.S. Cl. 356/237.5

(57) ABSTRACT

A semiconductor device fabrication-use mask pattern inspection apparatus having an optical configuration adaptable for achievement of a Koehler illumination system using a light source high in spatial coherency is disclosed. This apparatus includes a laser light source, a beam expander which is disposed between the laser source and a mask for expanding laser light to form an optical path of collimated light rays, and a beam splitter placed in the collimated light ray optical path for splitting the optical path into two optical paths. In one of these paths, a transmissive illumination optics is placed which irradiates transmission light onto the mask; in the other path, a reflective illumination optics is placed for irradiation of reflected light onto the mask. A pattern image of this mask is detected by a photosensitive device to generate a detected pattern image, which is sent to a comparator for comparison with a fiducial image thereof.

### CROSS-REFERENCE TO RELATED APPLICATION(S)

Priority is claimed to Japanese Patent Application No. 2007-046341, filed Feb. 27, 2007, the disclosure of which is incorporated herein by reference.

### TECHNICAL FIELD

The present invention relates to pattern inspection technologies. More particularly but not exclusively, this invention relates to a pattern inspection apparatus for testing for defects a circuit pattern of a photolithography mask to be used in the manufacture of highly integrated semiconductor devices.

### BACKGROUND ART

In recent years, as semiconductor integrated circuit devices further increase in integration density, a mask pattern for use in the manufacture of such devices is becoming smaller more and more in minimum feature size. To move with this mask pattern miniaturization, many currently available pattern inspection tools are designed to employ a laser light emitting device as a light source thereof. However, the laser light is inherently high in interference and, for this reason, suffers from unintentional occurrence of interference fringes, called the moire. This poses a serious bar to achievement of further miniaturization of semiconductor device products in near feature.

One proposed approach to reducing such moire is to use an optical system for illumination, which includes a phase plate having a myriad of stair step-like surface differences of less than or equal to the wavelength, which are formed or “carved” in a surface of the plate. This phase plate is driven by an electric motor to rotate at a predetermined speed. An example of this approach is disclosed in Published Unexamined Japanese Patent Application (PUJPA) No. 63-173322. Recently, it is needed to achieve an optical arrangement which is suitably employed to provide a Koehler illumination system using a laser light source.

### BRIEF SUMMARY OF THE INVENTION

It is therefore an object of this invention to provide a new and improved pattern inspection apparatus having an optical configuration adapted for achievement of the Koehler illumination system using a light source which is high in spatial coherency.

In accordance with one preferred form of the invention, a mask pattern inspection apparatus is provided, which includes a laser generation device for emitting laser light, a movable table structure supporting thereon a mask having a pattern, a beam expander which is disposed in a light path between the laser generation device and the mask for expanding the laser light to thereby form an optical path of collimated light rays, and a beam splitter placed in the optical path of the collimated light rays for dividing the above-noted light path into first and second light paths. A transmissive illumination optics is disposed in the first light path for irradiating transmitted light onto the mask whereas a reflective illumination optics is placed in the second light path for irradiating reflected light onto the mask. An optical pattern image of this mask is received and sensed by a photosensitive device, which issues at its output a sensed image signal. This signal is sent forth toward a comparator unit, which compares the pattern image with a fiducial image thereof.

In accordance with the invention, it is possible to optimize the layout of the rotatable phase plate and the beam splitter for separation of transmitted and reflected light rays. This in turn makes it possible to provide the intended optical arrangement suitable for achievement of the Koehler illumination system using the spatial coherency-enhanced light source.

### BRIEF DESCRIPTION OF THE DRAWINGS

FIG. 1 is a diagram showing, in process flowchart form, an entire configuration of a mask pattern inspection apparatus in accordance with one embodiment of this invention.

FIG. 2 is a diagram showing an optical arrangement of a pattern image creation device as used in the inspection apparatus shown in FIG. 1.

FIG. 3 is a block diagram showing an exemplary hardware configuration of main part of the pattern inspection apparatus of FIG. 1.

### DETAILED DESCRIPTION OF THE INVENTION

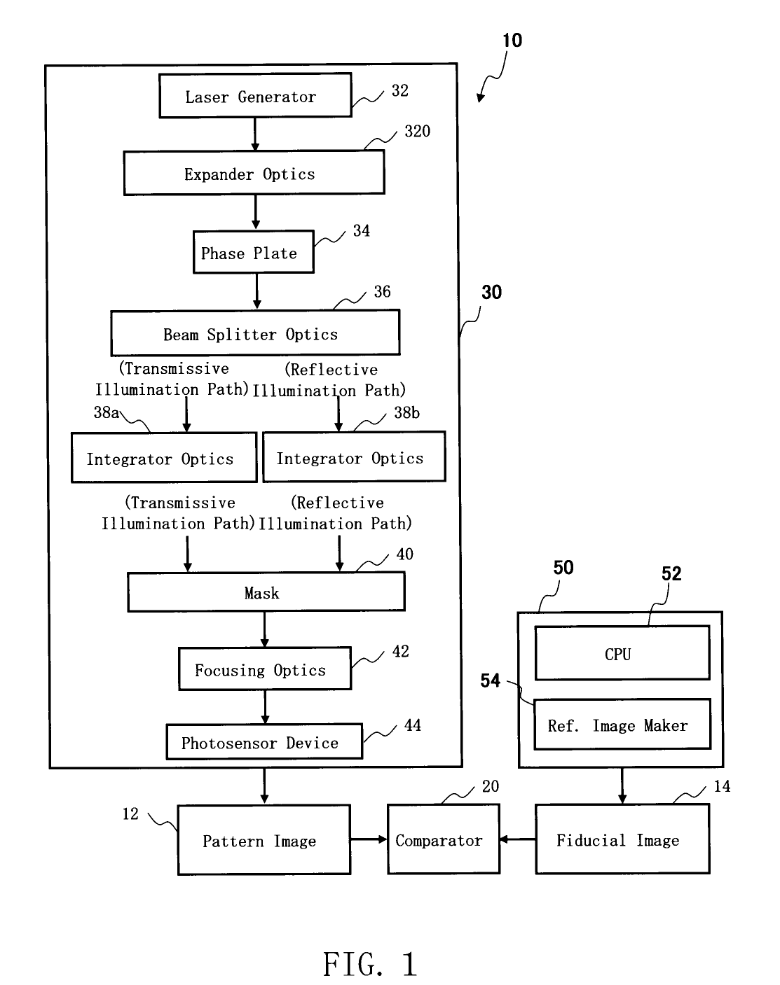

Referring to FIG. 1, there is shown an overall configuration of a mask pattern inspection apparatus 10 embodying the invention. This pattern inspection apparatus 10 is the one that inspects for defects a circuit pattern which is drawn or “written” on a photolithography mask 40 for use in the manufacture of highly integrated semiconductor circuit devices, such as ultra large-scale integrated (ULSI) circuit chips. This inspection apparatus includes a pattern image creation device 30 and an image comparing unit 20. The pattern image creator 30 operates to acquire an image 12 of the pattern of an ULSI circuit which is drawn on the mask 40 being tested. The comparator 20 compares this pattern image 12 with a standard or base image 14 which is for use as the fiducial image of the circuit pattern of mask 40, thereby to detect defects of the pattern, if any. This fiducial image 14 is typically a referencing image, which was obtained from the original or “master” circuit design data, such as computer-aided design (CAD) data, for manufacturing the circuit pattern of mask 40. Another example of the fiducial image 14 is a pattern image which is the standard or criterion that was obtained by the pattern image creator 30.

As shown in FIG. 1, the pattern image creator device 30 is generally made up of a laser emitting device 32 such as a laser light source, a beam expander optics 320, a rotatable phase plate 34, a beam splitter optics 36, a pair of integrator optics 38a and 38b, a movable table structure which supports thereon a workpiece under inspection, e.g., mask 40, and a photosensitive device 44 which receives incoming light rays.

The beam expander 320 functions to expand the laser light emitted from the laser emission device 32 to thereby convert it into collimated light rays traveling along a prespecified optical path. The beam expander 320 includes an expander lens or else.

The phase plate 34 is the one that realizes uniform illumination. An example of this phase plate is a transparent round disc-like plate having its surface in which small-size holes, called the pits, of different depths are formed or “carved.” The transparent disc plate may be made of glass or quartz. The pits are formed in an almost entire surface area of the phase plate 34 in such a way as to deviate or offset the phase of light that passes therethrough.

The beam splitter 36 is the one that divides the incident light path into a plurality of separate outgoing light paths. An example of the beam splitter 36 is a half mirror which is disposed so that it is slanted—typically, at an angle of 45 degrees—with respect to the optical axis of the incoming light path. This half mirror functions to split the incident light path into two optical paths, i.e., a path of light that passes through the mirror, and a path of light that is reflected therefrom. In other words, these optical paths are a transmissive illumination light path which guides transmitted light so that it falls onto the mask 40, and a reflective light path for irradiating reflected light onto mask 40.

The integrator optics 38a, 38b is the one that guides the collected or “condensed” light to cause it to reach the mask 40 at increased efficiency, while at the same time obtaining the uniformity of light on a top surface of mask 40. In the illustrative embodiment, an optical integrator is used therefor. As an example, the integrator optics 38a, 38b is structured from an ensemble of quartz lenses each having a compound-eye lens structure. Respective light rays that are irradiated onto the mask surface are integrated together thereon. Thus, a distribution of inplane brightness or luminance becomes uniform.

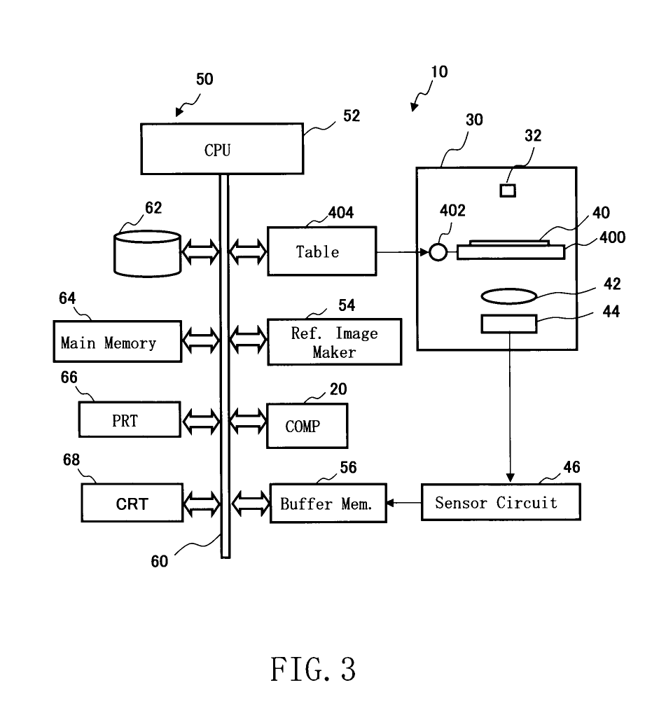

The mask 40 may be either a reticle or a photomask, which has on its surface a circuit pattern or patterns to be inspected. Mask 40 is stably mounted on the table structure, indicated by numeral 400 in FIG. 3, which is position-controlled three-dimensionally in three axis directions, i.e., X-direction, Y-direction, and θ-direction. A focusing optics 42 is provided for focusing the optical image of the pattern of mask 40 onto the photosensitive device 44. Typically, it is structured from a focusing lens or lenses. The photosensitive device 44 is the one that converts its sensed optical pattern image to a corresponding electrical image signal. An example of the device is a charge-coupled device (CCD) image sensor or a photodiode (PD) array.

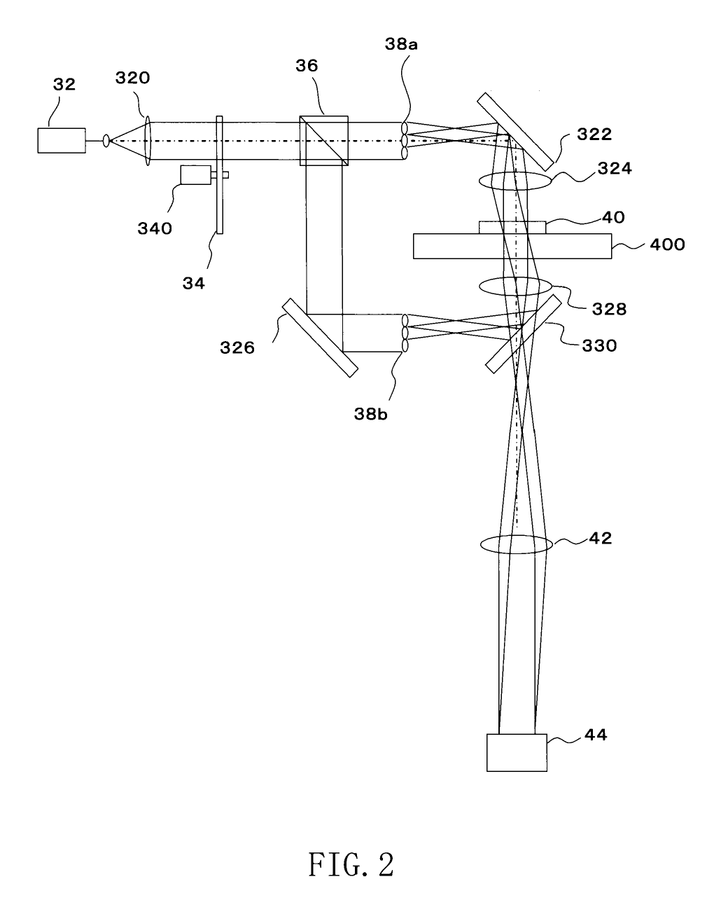

See FIG. 2, which depicts a pattern image projection device, which is one example of the pattern image creator 30 stated above. The laser light leaving the laser source 32 is expanded by the beam expander 320 into a radiation of collimated light rays. Thereafter, the laser light passes through the rotating phase plate 34 so that this light is reduced thereby in spatial coherency.

The rotatable phase plate 34 is placed in a light path between the expander lens 320 and the integrator optics 38a, along which path the collimated light rays of laser light progress or “fly.” With this layout arrangement, sufficient marginal spaces are held before and after the phase plate 34 to thereby minimize influences upon optical elements residing near or around phase plate 34, such as physical or mechanical vibrations occurring due to the operation of an electrical motor 340 that drives plate 34 for rotation, fluctuation of the ambient air, etc. Additionally, by placing phase plate 34 at a specific optical location that is after having expanded the laser light by the beam expander 320, the microstructure of phase plate 34 becomes relatively smaller with respect to the beam diameter of laser light, thereby improving disturbance effects.

After having passed through the phase plate 34, the laser light is split by the beam splitter 36 into two subbeams of light, i.e., a transmission light component progressing along a transmissive illumination light path, and a reflected light component traveling along a reflective illumination light path. In this embodiment, the transmissive illumination light path refers to an optical path which is formed by the beam splitter 36, integrator optics 38a, mirror 322 and condenser lens 324 whereas the reflective illumination light path is an optical path formed by the beam splitter 36, mirror 326, integrator optics 38b, half mirror 330 and objective lens 328. Letting beam splitter 36 be installed in the above-noted collimated light ray part makes it possible to freely perform the layout arrangement of the transmissive illumination light path and the reflective illumination light path.

The integrator 38a, mirror 322 and condenser lens 324 that are disposed to form the transmissive illumination light path function as a transmissive illumination optics. This optics is for irradiating the transmitted light onto the mask 40 being tested. The beam splitter 36, mirror 326, integrator optics 38b, half mirror 330 and objective lens 328 which form the reflective illumination light path function as a reflective illumination optics. This is to irradiate reflected light onto mask 40. More specifically, the light that is introduced into the transmissive illumination light path is split by integrator 38a; the light as introduced into the reflective illumination light path is split by integrator 38b via mirror 326. The light of the transmissive illumination light path is guided by the mirror 322 and condenser lens 324 to fall onto mask 40 to thereby achieve what is called the Koehler illumination. The light of the reflective illumination light path is projected onto mask 40 via half mirror 330 and objective lens 328 to thereby give it Koehler illumination.

Light rays that have penetrated the mask 40 or were reflected therefrom are collected together by the objective lens 328 and then pass through the half mirror 330 and next focused by the focusing optics 42 so that an image is formed on the photosensitive surface of sensor device 44.

In this way, the pattern image creator device 30 operates so that the spatial coherency is reduced by the rotating phase plate 34 after having expanded the laser light emitted from laser source 32 by beam expander 320. Very importantly, it is after the completion of this coherency reduction that the laser light is split into a couple of light components traveling along two separate optical paths—i.e., the above-stated transmissive illumination light path which is the optical path formed by the optical elements 36, 38a and 324, and the reflective illumination light path which is the other optical path formed by optical elements 36, 326, 38b, 330 and 328. In respective illumination light paths, separate integrators 38a and 38b are installed for producing area light sources used for Koehler illumination in a way independent of each other. Thereafter, Koehler illumination is given to the mask 40 by a known relay optics. This relay optics may be provided when the need arises.

It is noted that the pattern inspection tool 10 embodying the invention is arranged so that both the rotatable phase plate 34 and the transmission/reflection beam splitter 36 are disposed in the collimated light path, which is formed by the optical elements 320 and 38a. With such the phase plate layout design, it is possible to provide extra marginal spaces around the rotating body. This makes it possible to suppress or minimize influences of physical vibrations of the rotator, heat/air fluctuations, etc. Furthermore, by placing the transmission/reflection beam splitter 36 in the collimated light part, it becomes possible to increase the flexibility of free layout of the transmissive illumination light path and reflective illumination light path.

Turning to FIG. 3, there is shown an exemplary configuration of the mask pattern inspection apparatus 10 of FIG. 1. As shown herein, this inspection tool 10 is arranged to include a central data processing unit 50. Upon acquisition of a pattern image through detection of either the transmitted light or reflected light from the mask 40 by the pattern image creator device 30, the data processor 50 stores in its internal memory the data including design data of pattern image creator 30 and others. Data processor 50 functions to prepare from the design data a referencing image for use as the fiducial image 14 and also serves to perform a variety of kinds of digital arithmetic data processing.

The pattern image maker 30 operates to acquire a pattern image 12 from the circuit pattern of the mask 40 being tested. Mask 40 is stably situated on X-Y-θ table structure 400. This XYθ table may typically be a three-axis (X-Y-θ) manipulator, which is movable in X-axis and/or Y-axis direction and also is rotatable in θ direction. This manipulator is driven by electric motor 402, called the XYθ motor. This motor is drive-controlled by a table control unit 404, which operates in responding to receipt of a command(s) from the central data processor 52, in such a way as to move and/or rotate the XYθ table 400 in any one or ones of the X-, Y- and θ-directions. The XYθ motor 402 may be a known servo motor, a stepper motor or like motors. Position coordinates of XYθ table 400 are measured by a known laser-assisted length measurement system (not shown in FIG. 3) on a real time basis, and an output measurement signal of it is sent forth toward a position measurement unit (not shown). This unit generates at its output a data signal indicative of the position coordinate values of XYθ table 400, which is then fed back to the table controller 404.

The mask 40 is automatically loaded and mounted on the XYθ table 400 by an auto-loader (not shown) under the control of an auto-loader control unit (not shown), and is unloaded in an automated way after completion of inspection. At an upper part of the table 400, the laser emitting device 32 is disposed. Laser light from this device is irradiated onto mask 40 via either one of the transmissive illumination light path or the reflective illumination light path. The focusing optics 42 is disposed beneath mask 40. When the pattern image 12 of mask 40 is incident on photosensitive device 44, it is converted to a corresponding electrical image signal. Focusing optics 42 is subjected to automated focusing adjustment with the aid of a focus adjuster device (not shown), such as a piezoelectric element.

This focus adjuster is controlled by an auto-focus control circuit (not shown), which is connected to the central data processor 52. This focusing adjustment may alternatively be performed manually by an operator while monitoring using a separately provided observation scope. The photosensitive device 44 is a photodiode (PD) array module as an example. This PD array may be a linear sensor or an area sensor with a plurality of photodetective sensor elements. The PD array senses the pattern of the mask 40 while the XYθ table 400 is driven to move continuously in X-axis direction, thereby generating at its output a corresponding electrical measurement signal.

This measurement signal is converted by a sensor circuit 46 into digital data, which is input as the data of the sensed pattern image to a buffer memory 56 and then stored therein. This buffer memory 56 may be either a series connection or a parallel combination of more than two semiconductor memory units on a case-by-case basis. An output of buffer memory 56 is transferred via data bus 60 to the image comparator 20. An example of the pattern image data is 8-bit unsigned data indicative of the brightness or luminance of each picture element or “pixel.” Usually the pattern inspection tool 10 of this type reads these pattern data out of the above-noted PD array in a way synchronized with a clock frequency of about 10 to 30 megahertz (MHz) and deals with the data as raster-scanned two-dimensional (2D) image data through appropriate data sorting.

A procedure for acquisition of a pattern image is as follows. An optical image of the integrated circuit pattern of the mask 40 is obtainable by causing the pattern image maker 30 to scan the mask 40. This mask pattern is acquired, for example, as a pattern image of narrow and long strip-like segments, which are cut along the direction of one side (e.g., X direction) of mask 40. These strips are in the form of a stream. This stream is a pattern image of an ensemble of further elongated strips which are four-divided in the one-side direction, e.g., X direction. The four-divided stream will be called the sub-stream. This substream is cut into multiple portions in another direction at right angles to the X direction, e.g., Y direction. These cut pattern images are called the frame. An example of this frame is a dot pattern image which consists essentially of a matrix of 512 rows of pixels along X-direction and 512 columns of pixels in Y-direction. Additionally each pixel has a grayscale of 256 different gradation or “graytone” levels.

As shown in FIG. 3, the data processor 50 is generally made up of the central processor 52 which executes data processing, auto loader control unit which controls the auto-loader, table control unit 404 for controlling XYθ table 400, a reference image creation unit 54 which creates from design data a referencing image for use as the fiducial image 14 that resembles mask pattern image 12, comparator 20 which compares pattern image 12 and fiducial image 14 to inspect for defects the image being tested, buffer memory 56 for temporary storage of the data of pattern image 12, a position measurement unit which obtains a present position of mask 40 from the position data of XYθ table 400 as measured by the laser-aided length measurement system, external storage device 62 for storing therein software programs and a large amount of data, such as a database of design data, main memory 64 for storage of a software program(s) along with data necessary for execution of arithmetic processing, printer 66, and a display monitor such as a cathode ray tube (CRT) or liquid crystal display (LCD) panel. These components are operatively connected together via internal data bus 60. The design data of mask 40 is stored so that an entirety of inspection area is divided into strip-like areas, by way of example.

The reference image creator 58 expands the design data to form image data and then applies thereto the image processing, such as edge rounding and/or slight fogging of graphic forms or figures, to force it to have maximized similarity in shape to pattern image 12, thereby preparing the reference image required. In view of the fact that this reference image is created directly from the original circuit design data, the resulting image is free from unwanted deviations otherwise occurrable in the actually operating pattern image creator device 30, such as distortions, deformations, level fluctuations, graytone variations, etc.

Although the invention has been disclosed and illustrated with reference to a particular embodiment, the principles involved are susceptible for use in numerous other embodiments, modification and alterations which will be apparent to persons skilled in the art to which the invention pertains. For example, while in the apparatus configuration shown in FIG. 3 respective devices and/or functional units are arranged by hardware components such as electrical or electronic circuits, similar results are obtainable by replacing them with software programs or firmware modules. Alternatively, these may be combined together to provide a “hybrid” configuration. Additionally, various types of mask pattern testing systems may be established by using constituent parts or components as indicated in the embodiment stated supra in a combined way on a case-by-case basis. When the need arises, one or several functional components may be eliminatable from those shown in FIGS. 1-3. The invention is, therefore, to be limited only as indicated by the scope of the appended claims.

What is claimed is:

1. A pattern inspection apparatus comprising:
a laser generation device operative to generate laser light;
a movable table structure supporting thereon a mask having a pattern;
a beam expander disposed in a light path between said laser generation device and the mask, for expanding the laser light to thereby form an optical path of collimated light rays;
a beam splitter disposed in the optical path of the collimated light rays for dividing the light path into first and second light paths;
a transmissive illumination optics disposed in the first light path for irradiating transmitted light onto the mask;
a reflective illumination optics disposed in the second light path for irradiating reflected light onto the mask;
a photosensitive device receiving a pattern image of the mask; and
a comparing unit operative to compare the pattern image received by said photosensitive device to a fiducial image.

2. The apparatus according to claim 1, further comprising:
a phase plate disposed in an optical path between said beam expander and said beam splitter.

3. The apparatus according to claim 2, wherein each of said transmissive illumination optics and said reflective illumination optics includes an integrator optics.

4. An illumination system adaptable for use in pattern inspection apparatus, said system comprising:
a light source for emission of laser light;
an expander optical element provided in a light path between said light source and a workpiece under inspection having a pattern, for expanding the laser light to form collimated light rays along a prespecified optical path;
a rotatable phase plate for coherency reduction at a post-stage of the expander, said phase plate being disposed at a first position along the collimated light ray optical path;
a beam splitter provided at a post-stage of said phase plate and placed at a second position spaced apart from the first position along said collimated light ray optical path, for splitting the laser light into beam components travelling along two separate, first and second optical paths, respectively;
a first illumination optics provided in the first optical path for irradiating a transmission light beam corresponding to one of the beam components onto the workpiece; and
a second illumination optics provided in the second optical path for irradiating a reflection light beam corresponding to a remaining one of the beam components onto the workpiece.

5. The system of claim 4 wherein said phase plate includes a round disk-like transparent plate having holes different in depth from one another as formed in substantially an overall surface of said transparent plate for permitting phase shift of light passing therethrough.

6. The system of claim 4 further comprising:
an electrical motor for rotation driving of said phase plate.

7. The system of claim 4 wherein each of said first illumination optics and said second illumination optics includes an integrator optics.

8. The system of claim 7 wherein said illumination system is for giving Koehler illumination to the workpiece.

9. The system of claim 8 wherein said pattern inspection apparatus includes an apparatus for inspecting a pattern of a photolithography mask for use in fabrication of semiconductor integrated circuit devices.

10. The system of claim 9 wherein said workpiece includes any one of a photomask and a reticle.

11. An optical system having an optical arrangement for achieving Koehler illumination using a light source with enhanced spatial coherency, said optical system being adaptable for use in apparatus for testing for defects a pattern of a photolithography mask used in manufacture of semiconductor integrated circuit devices, said system comprising:
a laser light source;
a beam expander provided to receive laser light from the light source, for expanding the laser light to thereby form collimated light rays along a prespecified optical path;
a rotatable phase plate for coherency reduction as provided at a post-stage of said expander and placed in the collimated light ray optical path;
a beam splitter provided in said collimated light ray optical path at a post-stage of said phase plate, for splitting the laser light into beam components progressing along separate optical paths including a first optical path and a second optical path, said beam components including a transmission light beam and a reflection light beam;
a transmissive illumination optics provided in the first optical path for irradiating the transmission light beam onto a workpiece being inspected; and
a reflective illumination optics provided in the second optical path for irradiating the reflection light beam onto the workpiece.

12. The system of claim 11 wherein said phase plate includes a round disk-shaped transparent plate having pits of different depths as formed in a substantially entire surface thereof to permit phase shifting of light penetrating the pits and wherein the transparent plate is driven by an electric motor for rotation.

13. The system of claim 12 wherein said transmissive illumination optics and said reflective illumination optics include optical integrators, respectively.

14. The system of claim 13 wherein each said optical integrator is made up of an ensemble of quartz lenses each having a compound eye lens structure.
